(19) United States
(12) Patent Application Publication
(10) Pub. No.: US 2007/0052996 A1
(43) Pub. Date: Mar. 8, 2007

(54) Printing system

(75) Inventor: Ken Ota, Cupertino, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA SYSTEMS LABORATORY, INC.

(21) Appl. No.: 11/220,713

(22) Filed: Sep. 8, 2005

(51) Int. Cl. G06F 15/00

(52) U.S. Cl. 358/1.15

(57) ABSTRACT

The present application relates to a printing system in which a printing apparatus comprising a low-cost chip can be utilized and a high quality print can be obtained.

### FIELD

The present invention relates to a printing system.

### INTRODUCTION

With the advent and proliferation of a digital copying apparatus, people can take copies of a document with high image quality quickly and easily. As the digital copying machine spreads, an inexpensive digital copying machine is more desirable.

However, the inexpensive digital copying machine draws certain drawback. For instance, to make the digital copying machine less expensive, a low-cost chip is usually applied to the digital copying machine as an image processing unit and/or a control unit. The processing speed of the low-cost chip is not fast. Therefore, the copying speed of the inexpensive digital copying machine is slow due to the ability of the low-cost chip.

Therefore, it is desirable that the copy speed becomes faster and the image quality gets higher even though the digital copying machine is a low price machine comprising a low-cost chip.

### SUMMARY

According to various embodiments, the present teachings can provide a printing system. The printing system can comprise a host computer and a printing apparatus. The printing apparatus can comprise a scanning unit for scanning a document to obtain a document data, a print unit and a transmit unit for transmitting the document data to the host computer. The host computer can comprise an image processing unit for producing a print data by modifying the document data transmitted from the printing apparatus, a transmit unit for transmitting the print data to the printing apparatus. The transmit of the document data from the printing apparatus to the host computer, the process for producing the print data by the host computer and the transmit of the print data from the host computer to the printing apparatus can be accomplished without user-input to the host computer. The print unit can print according to the print data transmitted from the host computer.

### BRIEF DESCRIPTION OF THE DRAWINGS

FIG. 1 illustrates a block diagram of a printing system comprising several PCs and a color MFP, according to certain embodiments.

FIG. 2 illustrates a schematic cross sectional view showing overall construction of color MFP, according to certain embodiments.

FIG. 3 illustrates a graph showing relationship between the actual optical density data and pattern number of patch pattern

FIG. 4 illustrates a graph showing relationship between the actual optical density data and pattern number of patch pattern and the relationship between the ideal optical density data and pattern number of patch pattern.

FIG. 5 illustrates a flowchart describing the execution of the producing the printing apparatus condition data, according to certain embodiments.

FIGS. 6(a) and (b) illustrates a flowchart describing the execution of the copy function, according to certain embodiments.

### DESCRIPTION OF CERTAIN EMBODIMENTS

A Printing System

In certain embodiments, a printing system can comprise one or several host computer(s) and one or several printing apparatus(es). In certain embodiments, the printing system can comprise a network which connects the host computer with the printing apparatus.

Examples of the network consistent with certain embodiments of the invention include, but are not limited to, an internet, an intranet, a local area network (LAN) and a wide area network (WAN). The printing apparatus and the host computer can be connected with a wire or be connected with wireless by using radio frequency (RF) and/or infrared (IR) transmission.

In certain embodiments, the printing apparatus can obtain a document data by scanning an original document. Then, the printing machine can transmit the document data to the host computer. After the host computer receiving the document data, the host computer can produce a print data by modifying the document data automatically without user-input to the host computer. It is possible to conduct the complicated image processing calculation for a short period by utilizing the high performance CPU of the host computer. Then, the host computer can transmit the print data to the printing apparatus. The printing apparatus can print according to the print data.

The document data can include document, drawing, table, picture and/or photo and the like. The document data can be 8 bit bitmap data.

The print data can be data which complies with a format of the print unit of the printing apparatus so that the print unit can print according to the print data. For instance, the print data can be 1 bit bitmap data. In certain embodiments, the print data can be 1 bit bitmap data for each color of Y, M, C and K. In certain embodiments, the print data can be obtained by conducting the color conversion and the halftone processing to the document data of bitmap data.

(a) A Printing Apparatus

Examples of the printing apparatus consistent with certain embodiments of the invention include, but are not limited to, a digital copying apparatus (e.g., a laser beam copying machine, a multi function printer including copy function (MFP), an ink jet copying machine, a thermal copying machine (e.g., dye sublimation copying machines) and a silver halide copying machine). The laser beam copying machine or the MFP can be preferable.

In certain embodiments, the printing apparatus can comprise a scanning unit, a print unit and a transmit unit. In certain embodiments, the printing apparatus can further comprise a display unit, an input unit, a storing unit and an image processing unit. In certain embodiments, the printing apparatus can further comprise a detecting unit. In certain embodiments, the printing apparatus can further comprise a polling request producing unit.

In certain embodiments, the scanning unit can scan a document including a printed document, books, photos, paintings and the like to obtain a document data. Examples of the scanning section consistent with certain embodiments of the invention included, but are not limited to, an image reading unit, a flat bed image scanner and a handy scanner.

In certain embodiments, the print unit can print on a recording sheet according to a print data produced by the image processing unit. For instance, the recording sheet can be a paper, OHP film and so on. Examples of the print unit consistent with certain embodiments of the invention include, but are not limited to, a print engine or an image forming unit for the MFP and the laser beam copying machine, an ink jet head of the ink jet printer. In certain embodiments, the print engine or the image forming unit can comprise a laser beam scanning unit, a photo-sensitive drum (in other words, a photoconductor), a cleaning unit, an eraser lamp, a charging charger, a developing device, a transmit charger and so on. In certain embodiments, the print engine for the color copying machine or the color MFP can comprise one laser beam scanning unit and several imaging units corresponding to each color of C, M, Y and K and comprising the photo-sensitive drum, the cleaning unit, the eraser lamp, the charging charger, the developing device, the transmit charger and so on.

In certain embodiments, the transmit unit can transmit digital data (e.g., the document data, a printing apparatus condition data, a print condition) to the host computer or other devices and can receive digital data (e.g., the print data) from the host computer or the other devices. In certain embodiments, the transmit unit can transmit the printing apparatus condition data and/or the print condition with the document data to the host computer. Examples of the transmit unit consistent with certain embodiments of the invention include, but are not limited to, a LAN adapter, a modem and a network card.

In certain embodiments, the display unit can display an image and/or instruction according to digital data. Examples of the display unit consistent with certain embodiments of the invention include, but are not limited to, a liquid crystal display (LCD), a Braun tube, a cathode ray tube (CRT) and a plasma display panel.

In certain embodiments, the storing unit can store digital data (e.g., a document data, a print data and a printing apparatus condition data) and/or program. Examples of the storing unit consistent with certain embodiments of the invention include, but are not limited to, a memory (e.g., a random access memory (RAM) including NVRAM, M RAM, P RAM, Fe RAM, Flash RAM, and a read only memory (ROM)), a hard disk, a removable data recording medium recorder/reader. Examples of a removable data recording medium for the removable data recording medium recorder/reader include, but are not limited to, a digital memory card, a compact disk (e.g., CD-R, CD-RW, etc.), and a digital versatile disk (e.g., DVD-R, DVD-RW, DVD+RW, etc.). Various types of digital memory cards compatible with certain embodiments of the invention include, but are not limited to, a secure digital (SD) memory card, Compact Flash™, Smart Media™, Memory Stick™, and the like.

In certain embodiments, the user can input various information, instruction or response into the printing apparatus through the input unit. Examples of the input unit consistent with certain embodiments of the invention include, but are not limited to, a keyboard, a mouse, a push button and a touch panel.

In certain embodiments, the user can input a print condition including an image enhanced condition from the input section. For instance, the print condition can comprise a number of copies, a size of a paper, a print density, a zoom rate, a simplex or a duplex and the like. The image enhanced condition can comprise a sharpness change (changing sharpness) or correction(making sharpness closer to the original image), a color change (changing color) or correction(making color closer to the original image), a density change (changing density) or correction (making density closer to the original image)and the like.

In certain embodiments, the printing apparatus can have several print mode including a first print mode and a second print mode. In certain embodiments, a time for a print in the second print mode can be shorter than a time for a print in the first print mode. In certain embodiments, an image quality of a print in the second print mode can be higher than an image quality of a print in the first print mode. Higher quality can be more resolution, more sharpness, more similar color to the original document, more similar density to the original document and/or the like. For instance, the first print mode can be a normal print mode, and the second print mode can be a fast high quality mode. The user can select the first print mode or the second print mode by the input unit.

In certain embodiments, when the first print mode is selected, the printing apparatus can process the document data, produce the print data based on the document data without transmitting the document data to the host computer, and print according to the print data. When the second print mode is selected, the printing apparatus can transmit the document data to the host computer, the host computer can produce the print data based on the document data, the host computer can transmit the print data to the printing apparatus, and the printing apparatus can print based on the print data. Since an ability of the CPU or the MPU of the host computer is better than an ability of a low-cost chip of the printing apparatus, the second print mode can process more complicated image processing faster and print faster with higher image quality.

In certain embodiments, in case that the printing apparatus can have the first print mode and the second print mode, the printing apparatus can comprise the image processing section for producing the print data in the first print mode. In certain embodiments, the image processing unit can produce a print data by rasterizing the document data. In certain embodiments, the image processing unit can produce the print data which is 1 bit bitmap data for each color of Y, M, C and K by conducting color conversion which is from B, G and R to Y, M, C and K to the document data which is 8 bit bitmap data and then conducting a halftone processing to the data. In certain embodiments, the image processing unit can decompress the print data transmitted from the host computer. Examples of the image processing unit consistent with certain embodiments of the invention include, but are not limited to, a central processing unit (CPU) (with a memory and a software for producing the print data, if necessary) and an integrated circuit (IC), an application specific integrated circuit (ASIC), a field programmable gate array (FPGA) and a programmable logic device (PLD).

In certain embodiments, the printing apparatus can comprise the detecting unit which can detect a printing apparatus condition data. The detecting unit can detect the printing apparatus condition data of the print unit. In certain embodiments, the detecting unit can detect the printing apparatus condition data of the scanning unit. Examples of the detecting section consistent with certain embodiments of the invention include, but are not limited to, an optical density sensor, a temperature sensor, a humidity sensor, a touch sensor and a counter.

In certain embodiments, the printing apparatus condition data can be a data showing the condition of the printing apparatus. Examples of the printing apparatus condition data consistent with certain embodiments of the invention include, but are not limited to, a data of a temperature outside and/or inside of the printing apparatus, a data of a humidity outside and/or inside of the printing apparatus, a data of an amount of prints, a data of an optical density of a sample print, a data of an optical density of a sample pattern such as a patch pattern and a data of a density of a sample scan.

In certain embodiments, the printing apparatus condition data can be detected by the detecting unit when the printing apparatus is turned on. In certain embodiments, the printing apparatus condition data can be detected when the printing apparatus prints a predetermined amount of papers (e.g., every 100 sheets, every 200 sheets or the like). In certain embodiments, the printing apparatus condition data can be detected periodically (e.g., every day, every week, every month or the like). In certain embodiments, the printing apparatus condition data can be detected when an environmental condition of the printing apparatus changes drastically. For instance, the printing apparatus can judge that the environmental condition changes drastically if the difference of temperature outside and/or inside the printing apparatus between the current temperature and the temperature detected in the last time is more than 5° C., 10° C. or 15° C. or the temperature outside and/or inside the printing apparatus changes by 5° C., 10° C. or 15° C. within the predetermined period (e.g., 1 hour, 2 hours, 1 day and the like). In certain embodiments, the printing apparatus can judge that the environmental condition changes drastically, when the difference of humidity outside and/or inside the printing apparatus between the current humidity and the humidity detected in the last time is more than 5%, 10% or 15% or the humidity outside and/or inside the printing apparatus changes by 5%, 10% or 15% within the predetermined period (e.g., 1 hour, 2 hours, 1 day and the like).

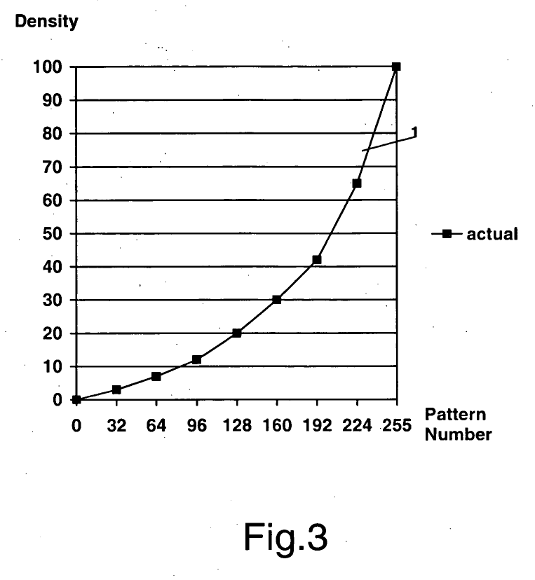

In certain embodiments, the optical density sensor as the detecting unit can detect the optical density data, which is the printing apparatus condition data, of the several patch patterns formed by the toner on the photoconductor or the transmit belt as the printing apparatus condition data. The several patterns correspond to several pattern numbers. In certain embodiments, as illustrated in FIG. 3, the optical density data 1 of several patch patterns formed on the photo conductor or the transmit belt can be detected by the optical density sensor. Each patch patterns is formed with data corresponding to each pattern number (e.g., 0^{th}, 32^{nd}, 64^{th}, 96^{th}, 128^{th}, 160^{th}, 192^{nd}, 224^{th}, 256^{th} and the like) of dither pattern. In certain embodiments, the optical density data of patch patterns for four, ten, twenty, forty or more pattern numbers can be detected. In certain embodiments, the optical density of the several kinds of pattern number for each color of Y, M, C and K can be detected.

In certain embodiments, the polling request producing unit can produce a polling request for finding the host computer which is connected to the printing apparatus, is turned on and has a capacity to produce a print data based on the document data obtained by the printing apparatus. The polling request can be transmitted by the transmit unit to the host computers via the network. The host computer which is turned on, includes the application software for producing the print data based on the document data and receives the polling signal can reply to the polling signal. After receiving the reply, the printing apparatus can transmit the document data to the host computer replying to the polling signal from the printing apparatus. The printing apparatus which can connect with the host computer according to the universal serial bus (USB) standard can conduct same function stated in the above. Examples of the polling request producing unit consistent with certain embodiments of the invention include, but are not limited to, a CPU (with a memory and a software for producing the polling request, if necessary) and an IC, an ASIC, a FPGA and a PLD. The polling request producing unit and the image processing unit can be integrated into one device or can be divided into several devices.

(b) A Host Computer

Examples of the host computer consistent with certain embodiments of the invention include, but are not limited to, a personal computer (PC) and a server computer. In certain embodiments, the host computer can comprise an image processing unit and a transmit unit. In certain embodiments, the host computer can comprise a display unit, a storing unit and an input unit.

In certain embodiments, the display section can display an image according to the data stored in the host computer. Examples of the display section consistent with certain embodiments of the invention include, but are not limited to, a LCD, a Braun tube, a CRT and a plasma display panel.

In certain embodiments, the transmit unit can transmit digital data (e.g., the print data) to the printing apparatus or other devices and can receive digital data (e.g., the document data, the printing apparatus condition data, the print condition) from the printing apparatus or the other devices. Examples of the transmit unit consistent with certain embodiments of the invention include, but are not limited to, a LAN adapter, a modem and a network card.

In certain embodiments, the storing unit can store digital data (e.g., the document data, the print data, the image enhanced data, the document data, the print data, the image enhanced data, the printing apparatus condition data and the like). Examples of the storing section consistent with certain embodiments of the invention include, but are not limited to, a memory (e.g., a RAM including NVRAM, M RAM, P RAM, Fe RAM, Flash RAM, and a ROM), a hard disk, a removable data recording medium recorder/reader.

In certain embodiments, the user can input various information, instruction or response into the host computer through the input section. Examples of the input section consistent with certain embodiments of the invention include, but are not limited to, a keyboard, a mouse, a push button and a touch panel.

Examples of the image processing unit with certain embodiments of the invention include, but are not limited to, a central processing unit (CPU) (in other words, a micro processing unit (MPU)) with a memory and a software for producing the image enhanced data, if necessary.

In certain embodiments, the image processing unit can produce the print data by modifying the document data transmitted from the printing apparatus. The image processing unit can produce the print data automatically without an user-input from the input unit of the host computer.

In certain embodiments, the image processing unit can produce the print data by rasterizing the document data. For instance, the image processing unit can produce the print data which is 1 bit bitmap data for each color of Y, M, C and K by conducting color conversion which is from B, G and R to Y, M, C and K to the document data which is 8 bit bitmap data and then conducting a halftone processing to the data. In certain embodiments, the image processing unit can conduct an image processing (e.g., changing sharpness, color, size, and/or density, and making sharpness, color, size and/or density closer to those of the original document and the like) to the document data according to the print condition including the image enhanced condition. In certain embodiments, the image processing section can compress the print data according to compression standard (e.g., JBIG, JPEG and the like).

In certain embodiments, the image processing unit can produce an image enhanced data. In certain embodiments, the image processing unit can produce the image enhanced data based on the printing apparatus condition data transmitted from the printing apparatus. The image processing unit can produce the print data by modifying the document data according to the image enhanced data.

In certain embodiments, the image enhanced data can be a correction data to correct the document data so that the print image can be a correct image. In certain embodiments, the image enhanced data can be a complementary data to enhance an image quality of the print image. Examples of the image enhanced data consistent with certain embodiments of the invention include, but are not limited to, a density correction data, a moiré removal data, a sharpness enhancement data and a color correction data.

In certain embodiments, the moiré removal data can be a data to remove the moiré from the print image. In certain embodiments, the color correction data can include the color correction data, the color brightness correction data and the color conversion data.

In certain embodiments, the density correction data can be a correction data to enhance the image quality of print and/or to make the print image close to the original image by adjusting or correcting the density. Examples of the data of the density correction data consistent with certain embodiments of the invention include, but are not limited to, a half-tone and a tone curve.

In certain embodiments, application software for producing the print data by modifying the document data can be installed into the host computer in addition to operating system (OS).

The removable data recording medium can store program for producing the print data and/or producing the image enhanced data.

### EXAMPLE

One example of the printing system is described in the following. This invention is not limited to the following example.

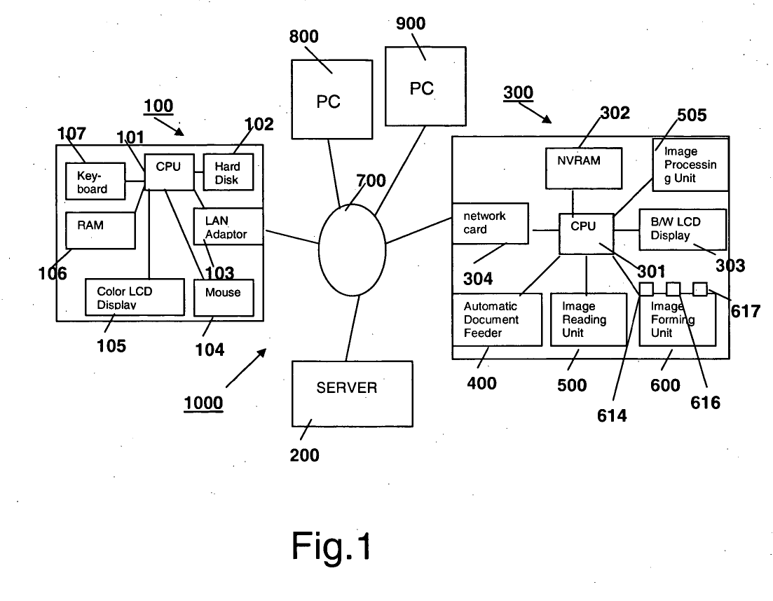

As illustrated in FIG. 1, the printing system (e.g., a printing system 1000) can comprise several host computesr (e.g., a PC 100, a PC 800 and a PC 900), a server (e.g., a server 200), a printing apparatus (e.g., a color multi functional printer (color MFP) 300) and a LAN 700 connecting the PC 100, the PC 800, the PC 900, the server 200 and the color MFP 300.

The PC 100 can comprise an image processing unit (e.g., a CPU 101 and a RAM 106 with necessary software for processing), an input unit (e.g., a mouse 104 and a keyboard 107), a storing unit (e.g., the RAM 106 and a hard disk 102), a display unit (e.g., a color LCD display 105) and a transmit unit (e.g., a LAN adaptor 103).

The OS and the application software (e.g., Microsoft Word, Adobe Photoshop and the like) recorded on a CD-ROM can be installed in the PC 100, the PC 800 and the PC 900. The application software for producing a print data based on a document data, producing an image enhanced data based on a printing apparatus condition data for the color MFP 300 recorded on a CD-ROM can be installed in the PC 100.

The color MFP 300 can provide a copy function, a scanner function and a printer function. The color MFP 300 can be a raster printer. As illustrated in FIG. 1, the color MFP 300 can comprise a storing unit (e.g., a NVRAM 302), an image processing unit (e.g., an image processing unit 505 and a CPU 301), a print unit (e.g., an image forming unit 600), a detecting unit (e.g., an optical density sensor 614, a counter (not shown), a temperature sensor 616 and a humidity sensor 617), a display unit (e.g., a black and white LCD 303), a scanning unit (e.g., an image reading unit 500), an input unit (e.g., an operation panel (not shown)), an automatic document feeder 400 and a transmit unit (e.g., a network card 304).

The ability of the CPU 101 of the PC 100 is higher than the ability of the CPU 301 of the color MFP 300.

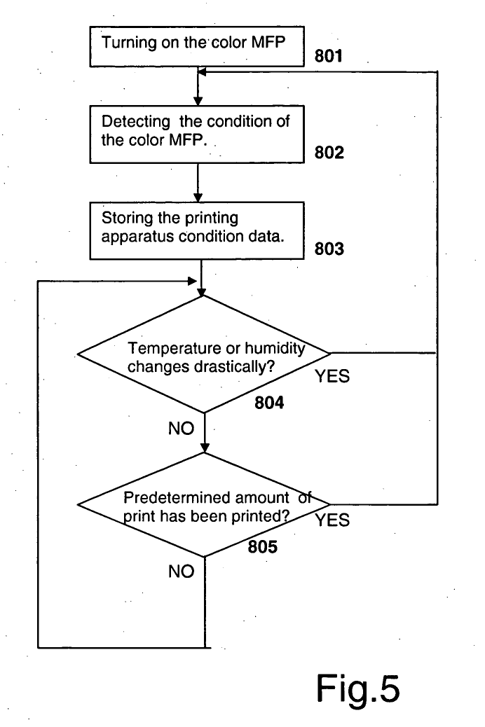

Here, first of all, the color MFP 300 can be turned on (801 in FIG. 5). Then, the optical density data as the printing apparatus condition data of the color MFP 300 can be detected as follows (802 in FIG. 5).

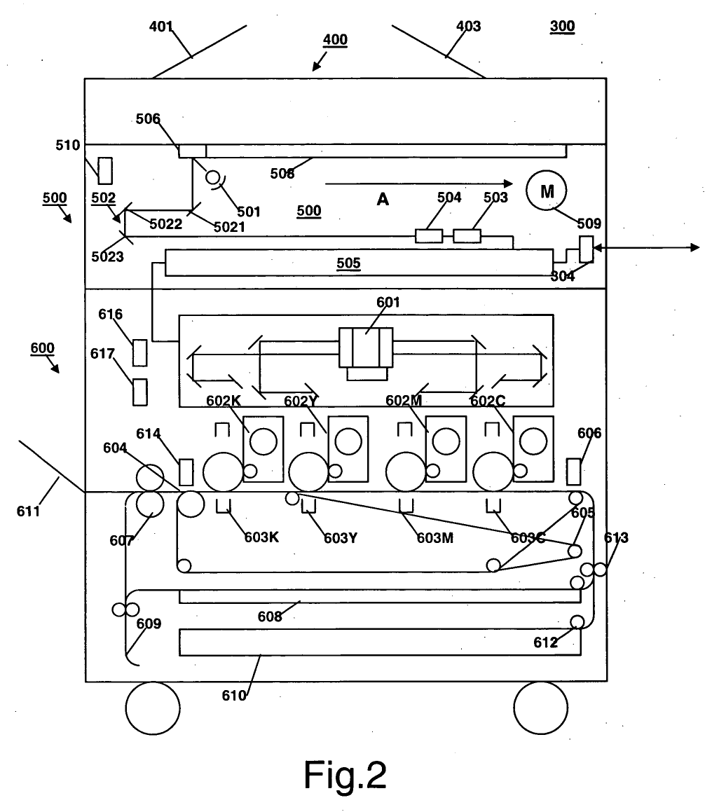

Patch patterns corresponding to several pattern numbers (e.g., 0th, 32nd, 64th, 96th, 128th, 160th, 192nd, 224th, 255th) for each color of C, M, Y and K can be formed on the paper transport belt 604 as illustrated in FIG. 2. Data of each pattern numbers can be stored in the NVRAM 302 of the color MFP 300 beforehand. In this example, 36 patch patterns (9 pattern numbers×4 colors) can be formed on the paper transport belt 604. When the patch patterns are formed on the paper transport belt 604, the optical density of each of 36 patch numbers can be detected by the optical density sensors 614. In this example, the optical density 1 of each of 36 patch numbers can be shown in FIG. 3. The printing apparatus condition data 1 can be stored in the NVRAM 302. (803 in FIG. 5)

After tuning on the color MFP, if the temperature sensor 616 detects that the difference between current temperature and the temperature at the last detection of the printing apparatus condition data is 10° C. or more, or the humidity sensor 617 detects that the difference between current humidity and the humidity at the last detection of the printing apparatus condition data is 10% or more, the printing apparatus condition data of the color MFP 300 can be detected again by the way mentioned in the above (804 in FIG. 5). The new printing apparatus condition data can be stored in the NVRAM 302.

After tuning on the color MFP, if the counter (not shown) counts a predetermined amount of prints(e.g., every 200 sheets), the printing apparatus condition data of the color MFP 300 can be detected again by the way mentioned in the above (805 in FIG. 5). The new printing apparatus condition data of the image forming unit 600 and the image reading unit 500 can be stored in the NVRAM 302.

When the new printing apparatus condition data is stored in the NVRAM 302, the old printing apparatus condition data can be deleted from the NVRAM 302.

Here, for the copy function, an image can be typically formed in the following way.

The color MFP 300 can provide two print modes which are a first print mode (e.g., a normal copy mode or a stand alone copy mode) and a second print mode (e.g., a high quality copy mode or a network copy mode).

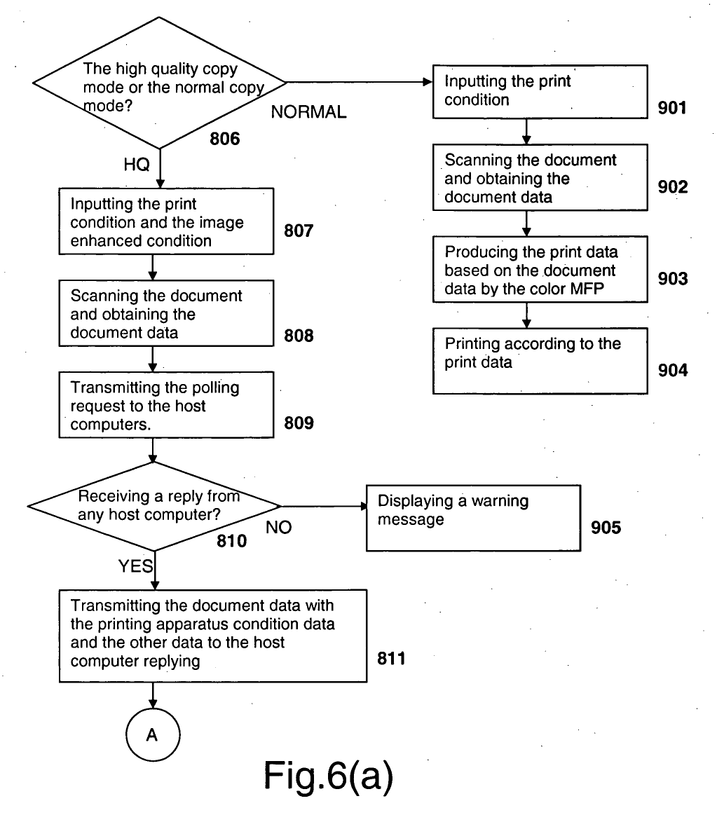

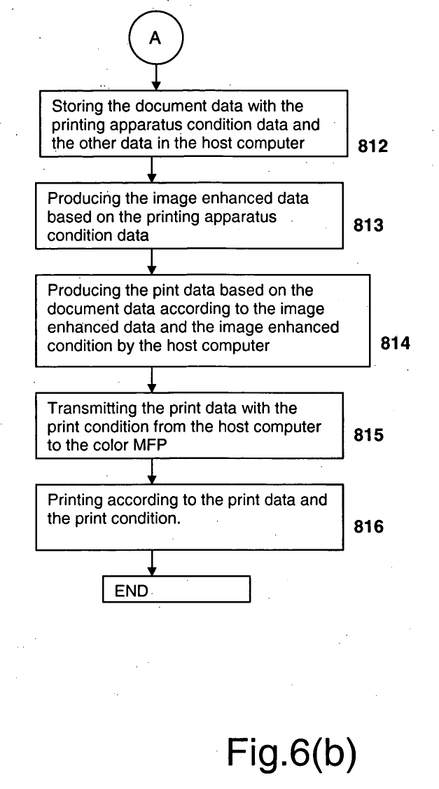

In this example, the user can select the high quality copy mode by inputting instruction from the operation panel of the color MFP 300. (806 in FIG. 6(a)) Also, the user can input a print condition (e.g., a paper size is A4, a number of copies is 10, 100% zoom rate, a simplex print and the like) from the operation panel. (807 in FIG. 6(a)) Further, the user can input an image enhanced condition (e.g., emphasizing sharpness) from the operation panel. (807 in FIG. 6(a)) In certain embodiments, the print condition and the image enhanced condition can be stored in the NVRAM 302.

Then, as illustrated in FIGS. 1 and 2, a document can be fed to an image reading position by the automatic document feeder 400. The automatic document feeder 400 can feed a document set on a document feed tray 401 to the image reading position of the image reading unit 500, and after the image is read, can discharge the document to a document discharge tray 403. The document transportation operation can be accomplished in accordance with instructions from the operation panel (not shown), and the document discharge operation can be accomplished in accordance with a reading end signal from the image reading unit 500. When a plurality of documents are stacked on the document feed tray 401, these control signals can be continuously generated to sequentially transport the documents, read images of the documents, and discharge the documents.

A white shading correction plate 506 can be arranged in close proximity to the document reading start position of the document glass 508. Prior to reading the document, the shading correction plate 506 can be read to generate one of the printing apparatus condition data for shading correction. The data can be stored in the NVRAM 302.

In the image reading unit 500, an exposure lamp 501 can illuminate the document placed on a document glass 508, and a mirror group 502 including three mirrors 5021 to 5023 and a lens 503 can direct the light reflected by the document to form an image on a CCD sensor 504. The exposure lamp 501 and the first mirror 5021 can be driven by a scan motor 509 in the direction of arrow A at a speed V corresponding to the magnification ratio, so as to scan the entire surface of the document placed on the document glass 508. While the document is being scanned using the exposure lamp 501 and the first mirror 5021, the second mirror 5022 and the third mirror 5023 can move in the direction of arrow A at a speed V/2. The position of the exposure lamp 501 can be calculated and controlled, using the amount of movement from the home position, i.e., using the number of steps of the scan motor 509 and detection signals from a scan home position sensor 510. The reflected light entering the CCD sensor 504 can be converted into electric signals within the CCD sensor 504. The image processing unit 505 then can subject the electric signals to various image processing, such as analogue processing, analogue-to-digital (AD) conversion and the document data which is the bitmap data of 8 bit for each color for R(red), G(green) and B(blue) can be obtained. The document can be read by the image reading unit 500 which is a flat bed optical image scanner comprising the image processing unit 505 having the CPU 301 to obtain a document data as disclosed in the above. (808 in FIG. 6(a)) The document data can be stored in the NVRAM 302.

After that, a polling request for finding the host computer which is connected to the LAN 700, is turned on and has a capacity to produce a print data based on the document data obtained by the color MFP 300 can be produced by the CPU 301 voluntary. (809 in FIG. 6(a)) The polling request can be transmitted from the network card 304 of the color MFP 300 to the PC 100, the PC 800 and the PC 900 via the LAN 700. In this example, the PC 800 is turned off. Therefore, the PC 800 does not reply to the polling request. In this example, the application software for producing the print data based on the document data is not installed in the PC 900. Therefore, the PC 900 does not reply to the polling request. The PC 100 is turned on and the application software for producing the print data based on the document data is already installed in the PC 100. Therefore, after the PC 100 receives the polling request through the LAN adaptor 103, the PC 100 can send a reply informing that the PC 100 can process the document data from the LAN adaptor 103 to the color MFP 300 via the LAN 700. (810 in FIG. 6(a))

In certain embodiments, if there is no host computer which is connected to the LAN 700, is turned on and has the capacity to produce the print data, the color MFP 300 cannot receive a reply. In that case, the black and white LCD display 303 can display warning message stating that the high quality copy mode cannot be executed in the current situation. (905 in FIG. 6(a))

If the color MFP 300 receives the reply from the PC 100, the document data stored in the NVRAM 302 can be voluntary transmitted from the network card 304 to the PC 100 via the LAN 700. (811 in FIG. 6(a)) In addition, the print condition (e.g., A4, 10 copies, 100% zoom rate, a simplex), the image enhanced condition (e.g., emphasizing sharpness) and the printing apparatus condition data (e.g., the optical density of each of 36 patch numbers, and the data for the shading correction) stored in the NVRAM 302 can be voluntary transmitted with the document data from the network card 304 to the PC 100 via the LAN 700. (811 in FIG. 6(a))

The PC 100 can receive and the hard disk 102 or the RAM 106 can store the document data, the print condition, the image enhanced condition and the printing apparatus condition data. (812 in FIG. 6(b))

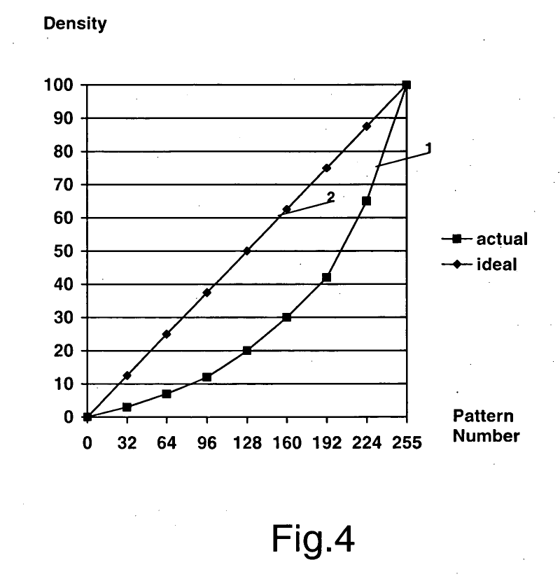

Then, the PC 100 can voluntary start to produce the image enhanced data based on the printing apparatus condition data. (813 in FIG. 6(b)) The hard disk 102 of the PC 100 can store ideal optical density data as ideal printing apparatus condition data. In this example, the ideal optical density data 2 can be illustrated in FIG. 4. The ideal printing apparatus condition data can be stored in the hard disk 102 when the application software for producing the print data based on the document data including the ideal printing apparatus condition data is installed in the PC 100.

After the PC 100 receives the printing apparatus condition data, the CPU 101 can compare the actual optical density data 1 as the actual printing apparatus condition data sent from the color MFP 300 with the ideal optical density data 2 as the ideal printing apparatus condition data. According to the result of the comparison between the detected optical density data 1 and the ideal optical density data 2, the CPU 101 with the application software can produce a halftone data by reorganizing a halftone data according to an inverse function so that the actual optical density data 1 can be getting same or close to the ideal optical density data 2. In this example, the halftone data can be the image enhanced data. The half tone data can be further adjusted according to the data for shading correction. The halftone data as the image enhanced data can be stored in the hard disk 102 or the RAM 106. In another embodiment, the image processing unit can produce the tone curve as the image enhanced data by reorganizing the tone curve according to the inverse function so that the actual optical density data 1 can be getting same or close to the ideal optical density data 2.

Then, the PC 100 can voluntary start to produce the print data based on the document data according to the image enhanced condition and the image enhanced data. (814 in FIG. 6(b)) The CPU 101 with the application software can perform sharpness emphasizing process to emphasize the sharpness of the document data according to the image enhanced condition transmitted from the color MFP 300. The conventional way to emphasize the sharpness can be applied to this example. Then, the CPU 101 can conduct color conversion to the 8 bit bitmap data and produce the 8 bit bitmap data for each color of Y(yellow), M(magenta), C(cyan) and K(black). The CPU 101 can conduct the halftone processing to the 8 bit bitmap data according to the halftone data as the image enhanced data and produce the print data which is the 1 bit bitmap data for each color of Y, M, C and K. Therefore, the CPU 101 as the image processing unit can produce the print data by rasterizing the document data according to the halftone data as the image enhanced data and the image enhanced condition.

Then, the CPU 101 can compress the print data according to JBIG format and produce a print job including the compressed print data and the print condition. Then, the print job can be transmitted from the LAN adaptor 103 of the PC 100 to the color MFP 300 through the LAN 700. (815 in FIG. 6(b))

The network card 304 of the color MFP 300 can receive the print job. The image processing section 505 having the CPU 301 can decompress the print data included in the print job and the color MFP 300 can obtain the print data.

The print data can be transmitted to the image forming unit 600. The image forming unit 600 of the color MFP 300 can print according to the decompressed print data and the print condition by the way disclosed in the following. (816 in FIG. 6(b))

Next, the following describes the image forming unit 600. First, exposure and imaging are described.

The print data of each of colors C, M, Y, and K transmitted from the PC 100 can be transmitted to a control unit of each exposure head (not shown). The control unit of each exposure head can make a laser emit a laser beam in accordance with a pixel value of the print data, and perform a one-dimensional scan with the emitted laser beam via a polygon mirror 601, to optically expose the surface of a photoconductor in each of the imaging units 602C, 602M, 602Y, and 602K.

In each of the imaging units 602C to 602K, elements required for an electrophotographic process can be arranged around the periphery of a photoconductor. The electrophotographic process is continuously performed as the photoconductor for each of C, M, Y, and K can be rotated clockwise. The imaging units 602C to 602K necessary for forming an image each can be integrated, and can be detachable from the body. The latent images formed on the photoconductors in the imaging units 602C to 602K by the above exposure can be developed by developing units of respective colors. The toner images developed on the surface of the photoconductors in the imaging units 602C to 602K can be transmitted onto a recording sheet transported on a paper transport belt 604, by transmit chargers 603C to 603K respectively arranged to face the photoconductors in the imaging units 602C to 602K within the paper transport belt 604.

The following describes the recording sheet feeding, transport, and fixing operations. The recording sheet onto which an image is to be transmitted can be fed to the transmit position in the following sequence and the image can be formed on the recording sheet. Recording sheets are loaded beforehand in paper feed cassette 610. A recording sheet can be fed to the transport path by the paper feed roller 612 mounted on the paper feed cassette 610.

The recording sheet fed to the transport path can be transported onto the paper transport belt 604 by a transport roller pair 613. Here, a reference mark on the paper transport belt 604 can be detected by a timing sensor 606, so that a transport timing of the recording sheet can be adjusted. Also, in the imaging units 602C to 602K, three optical density sensors 614 can be arranged along the main scanning direction furthest downstream in the direction of the transportation of the recording sheet. When a registration pattern is formed on the paper transport belt 604, the amount of color aberration can be detected in the main scanning direction and the sub scanning direction of the C, M, Y, and K images by the optical density sensors 614. Print image correction and image distortion correction can be performed by a print image control unit (PIC unit). As a result, color aberration on the recording sheet can be prevented. The toner image transmitted onto the recording sheet can be fused and fixed thereon via heating by the fixing roller pair 607, and then the recording sheet can be discharged to a discharge tray 611.

Note that in the case of duplex copies, an image can be formed on the back side of the recording sheet in the following way. The recording sheet on which the toner image is fixed by the fixing roller pair 607 can be inverted by a paper inverting unit 609, and is guided to a duplex unit 608, which re-feeds the recording sheet to the transport path. Note also that the paper transport belt 604 can be retracted from the imaging units 602C, 602M, and 602Y of colors C, M, and Y, by up and down movement of a belt retracting roller 605, so as not to contact the photoconductors therein. When a monochrome image is formed, therefore, the imaging units 602C, 602M, and 602Y are not driven. This can decrease wear of the photoconductors and the other components in the imaging units 602C, 602M, and 602Y.

In this example, A4 10 copies of the document image whose sharpness is emphasized and whose density is corrected can be obtained. During the above procedure from the reading the document to the printing, the process can be conducted without any direct user-input to the PC 100. During the above procedure, the user does not need to input or instruct anything from the input unit of the PC 100. The user operates only the MFP 300 and inputs the instruction only from the operation panel of the color MFP 300.

In certain embodiments, if the user selects the normal copy mode (or stand alone copy mode) by inputting instruction from the operation panel of the color MFP 300, the user cannot input the image enhanced condition from the operation panel while the user can input the other print condition. (901 in FIG. 6(a))

By scanning and processing by the image processing unit 505, the document data which is the 8 bit bitmap data for each color for R, G and B can be obtained. (902 in FIG. 6(a))

Then, the document data can be processed to produce the print data by the image processing unit 505 without transmitting the document data to the PC 100. The image processing unit 505 can subject the document data to the color conversion and the 8 bit bitmap data for each color of Y, M, C and K can be obtained. Then, the image processing unit 505 can subject the 8 bit bitmap data to the halftone processing without the image enhanced data and the print data of 1 bit bitmap data for each color of Y, M, C and K can be obtained. (903 in FIG. 6(a)) After that, the image forming unit 600 can print according to the print data by the way disclosed in the above. (904 in FIG. 6(a))

Since the capacity of the CPU 301 of the color MFP 300 is not as high as the capacity of the CPU 101 of the PC 100, the processing speed of the normal copy mode is slower and the image quality of the normal copy mode is not higher than those of the high quality copy mode.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A printing system comprising:
a printing apparatus, comprising;
a scanning unit which scans a document to obtain a document data,
a print unit, and
a transmit unit which transmits the document data to a host computer, and
the host computer, comprising;
an image processing unit which produces a print data by modifying the document data transmitted from the printing apparatus,
a transmit unit which transmits the print data to the printing apparatus,
wherein the transmit of the document data from the printing apparatus to the host computer, the process for producing the print data by the host computer and the transmit of the print data from the host computer to the printing apparatus is accomplished without user-input to the host computer, and
wherein the print unit prints according to the print data transmitted from the host computer.

2. The printing system of claim 1,
wherein the printing apparatus further comprises an image processing unit and an input unit,
wherein the printing apparatus prints in a first print mode or a second print mode, and an user selects the first print mode or the second print mode by the input unit,
wherein when the first print mode is selected, the image processing unit of the printing apparatus processes the document data, produces the print data and print section prints based on the print data without transmitting the document data to the host computer, and
wherein when the second print mode is selected, the transmit unit of the printing apparatus transmits the document data to the host computer, the image processing unit of the host computer produces the print data by modifying the document data and the transmit unit of the host computer transmits the print data to the printing apparatus and the print unit prints based on the print data.

3. The printing system of claim 2, wherein a time for a print in the second print mode is shorter than a time for a print in the first print mode.

4. The printing system of claim 2, wherein an image quality of a print in the second print mode is higher than an image quality of a print in the first print mode.

5. The printing system of claim 1,
wherein the printing apparatus further comprises a detecting unit which detects a printing apparatus condition data,
wherein the transmit unit of the printing apparatus transmits the printing apparatus condition data to the host computer, and
wherein the image processing unit of the host computer produces an image enhanced data based on the printing apparatus condition data and produces the print data by modifying the document data according to the image enhanced data.

6. The printing system of claim 5, wherein the image enhanced data is a density correction data.

7. The printing system of claim 6, wherein the density correction data is a half-tone.

8. The printing system of claim 6, wherein the density correction data is a tone curve.

9. The printing system of claim 5, wherein the image enhanced data is a moiré removal data.

10. The printing system of claim 1,
wherein the printing system comprises a plurality of the host computers, and
wherein the printing apparatus seeks the host computer which is turned on and has a capacity to produce the print data based on the document data, and the printing apparatus transmits the document data to the host computer which is turned on and has a capacity to produce the print data based on the document data.

11. The printing system of claim 1,
wherein the printing apparatus further comprises an input unit by which an user inputs a print condition including an image enhanced condition to the printing apparatus,
wherein the transmit unit of the printing apparatus transmits the print condition including the image enhanced condition with the document data to the host computer,
wherein the image processing unit of the host computer produces the print data by modifying the document data according to the image enhanced condition.

12. The printing system of claim 11, wherein the image enhanced condition is a sharpness.

13. A computer readable medium containing a computer program for image processing a document data obtained by a printing apparatus, the program containing instructions for directing the computer to execute the steps of:
receiving a document data from a printing apparatus,
producing a print data to be used for printing by the printing apparatus based on the document data,
transmitting the print data to the printing apparatus.

14. A computer readable medium containing a computer program for copying a document scanned by a printing apparatus, the program containing instructions for directing the computer to execute the steps of:
scanning a document to obtain a document data,
transmitting the document data to a host computer to make the host computer produce a print data based on the document data,
receiving the print data transmitted from the host computer, printing based on the print data.

15. A digital copying apparatus comprising:
a scanning unit which scans a document to obtain an document data,
a transmit unit which transmits the document data to a host computer in order to make the host computer produce a print data based on the document data, and receives the print data transmitted from the host computer, and
a print unit which prints based on the print data, and
wherein the transmit of the document data from the digital copying apparatus to the host computer, the process for producing the print data by the host computer and the receipt of the print data by the digital copying apparatus is accomplished without user-input to the host computer.
